(19) United States
(12) Patent Application Publication
(10) Pub. No.: US 2020/0070383 A1
(43) Pub. Date: Mar. 5, 2020

(54) ADDITIVELY MANUFACTURED OBJECT FABRICATION VESSEL

(71) Applicants: Daniel William PLACE, Los Angeles, CA (US); Garth Alexander SHELDON-COULSON, Moorpark, CA (US); Brian Lee MOFFAT, Simi Valley, CA (US)

(72) Inventors: Brian Lee Moffat, Portland, OR (US); Daniel William Place, Portland, OR (US); Garth Alexander Sheldon-Coulson, Portland, OR (US)

(21) Appl. No.: 16/614,609

(22) PCT Filed: May 25, 2018
(86) PCT No.: PCT/US18/34745

§ 371 Date: Nov. 18, 2019

Related U.S. Application Data
(60) Provisional application No. 62/512,002, filed on May 27, 2017.

(51) Int. Cl. B28B 1/00; B63C 1/02

(52) U.S. Cl. CPC B28B 1/001; B33Y 40/00; B63C 1/02

(57) ABSTRACT

A vessel and method for the production, transport, and deployment of additively-manufactured objects is disclosed, where the vessel and method permit the efficient fabrication and deployment of additively manufactured objects on and into a body of water. Additively manufactured objects are manufactured and/or fabricated directly on a vessel which can lower itself into the water, thereby facilitating the deployment of said objects.

### CROSS-REFERENCES TO RELATED APPLICATIONS

This application is based on PCT/US2018/34745, filed on May 25, 2018, which claims priority from U.S. application Ser. No. 62/512,002, filed May 27, 2017, the contents of which are fully incorporated by reference herein in its entirety.

### SUMMARY OF THE INVENTION

This disclosure, as well as the discussion regarding same, is primarily made in reference to wave energy converters, their associated flotation modules, as well as their associated submerged components (if any). However, the scope of this disclosure applies with equal force and equal benefit to any device, system, module, and/or apparatus, that involves a component fabricated via an extrusion of an extrudable material and/or substance, including an extrusion of said material through the “nozzle” of a 3D printer.

This disclosure, as well as the discussion regarding same, is made in reference to wave energy converters that can be deployed on, at, or below, the surface of an ocean. However, the scope of this disclosure applies with equal force and equal benefit to the manufacture of wave energy converters and/or other devices on, at, or below, the surface of an inland sea, a lake, and/or any other body of water or fluid. This disclosure, as well as the discussion regarding same, applies with equal force and equal benefit to the manufacture of: boats, buoys, barges, buoyant habitable structures (e.g., seasteading), bridges, artificial reefs, breakwaters, pipes and/or portions thereof (e.g., pipes utilized for the submerged transmission of fluids like sewage, oil, desalinated water, etc.), and other structures, objects, vessels, chambers, etc., that float at the surface of a body of water, rest on the ground beneath a body of water, and/or rest on ground above the surface of a body of water wherein at least a portion of that ground is proximate to a body of water.

This disclosure, as well as the discussion regarding same, is primarily made in reference to buoyant structures. However, the scope of this disclosure applies with equal force and equal benefit to any device, system, module, and/or apparatus, that is not buoyant. For example, the current disclosure has equal utility with respect to the design and/or fabrication of submerged “inertial” or “reaction” masses, vessels, containers, and/or other water-filled components.

Disclosed are:

a novel fabrication vessel for producing additively manufactured objects (AMOs);

a novel dockside structure for producing additively manufactured objects;

a method for the fabrication and transport of additively manufactured objects (“AMOs”);

and, a method for deployment of AMOs into a body of water.

Objects created via additive manufacturing can be fabricated at their final place of usage or else transported to their final place of usage. In the latter case, for large, heavy objects (e.g., greater than 10,000 kg), special lift and transport fixtures/equipment may be required. The present disclosures eliminate the need for special lift and transport fixtures/equipment because the objects are created directly on a vessel that transports them to a deployment location, or that is already positioned at a deployment location.

The vessels upon and/or within which the objects are created can also deploy the objects into, and/or on to, a body of water simply by lowering themselves deeper into the water, and allowing and/or compelling the objects to float away or be otherwise removed from the vessel (such as using a winch, crane, arm, motorized track, or any other mechanized or human-powered separation means). This means that the objects may never need to be moved from the surface on which they were fabricated and/or built until their time of deployment.

In one preferred embodiment the fabrication vessel is buoyant, and/or adjustably buoyant, and has at least one deck that can be submerged below a water surface while retaining the ability to return the deck to a position above the water surface.

The fabrication vessel may be a boat, ship, barge, platform, submarine, or any other object which is able to float in, and/or on, water. One embodiment of this type of structure shares many attributes, features, and/or characteristics, with the “floating dry docks” used in ship construction and repair. The floating structures utilized in the currently disclosed AMO fabrication method will often herein be referred to as floating dry docks (“FDDs”), but they may be any kind of floating structure.

The disclosed AMO fabrication method utilizes a large floating dry dock with one or more additive manufacturing devices (“AMDs”), colloquially known as 3D printers, installed on board. This embodiment shall be referred to as an additive manufacturing floating dry dock (“AMFDD”).

In one embodiment, the AMD installed aboard the AMFDD is constructed similar to a gantry crane, where movement of a stage is allowed in at least three axes (i.e., forward/aft, port/starboard, up/down) and where the largest spanning member is supported at either of its long-axis ends. In other embodiments, the AMD can be similar to a boom crane, a-frame crane, or be cable supported. The movable stage can contain at least some of the necessary equipment for additive manufacturing (e.g. nozzles, heating elements, hoppers, mixers, measuring equipment, etc.) but need not contain all of this equipment. The stage can support the deposition or extrusion of one or more types of materials such as cement, foam, plastic, composites, metal, wax, sand, gypsum, paper, rebar, mesh, fabric, or any combination thereof from a single material orifice and/or nozzle or from multiple material orifices and/or nozzles.

One embodiment utilizes smaller FDDs as production surfaces upon which AMOs are constructed. They are also the structures that are used to transport AMOs constructed by the AMFDD. They can also be used to deploy AMOs into, and/or on to, a body of water. These smaller FDDs shall be referred to as build and transport floating dry docks (“BTFDDs”) in this application. An advantage of embodiments utilizing BTFDDs is that an AMFDD or dockside embodiment can have greater “throughput” if it is used in combination with multiple BTFDDs, since this allows additively manufactured objects to be quickly removed from the manufacturing area once their manufacture is complete, even if further “curing” of said objects is required before they are allowed to be deployed into or onto the body of water. This “curing” can instead take place on the bed or platform of a (relatively less expensive) BTFDD.

An embodiment utilizing BTFDDs includes at least one AMFDD which can lower itself into the water such that its deck is sufficiently submerged for at least one BTFDD to float above and/or off the AMFDD's deck. A BTFDD can be positioned over the submerged deck of the AMFDD such that when the AMFDD raises its deck above the water surface, and/or when the BTFDD lowers its keel to a greater depth, the keel of the BTFDD (or some other bottom portion thereof) will then be resting on the AMFDD's deck. This rigidly positions the BTFDD upon the AMFDD deck in preparation for the manufacturing of AMOs.

The AMD(s) onboard the AMFDD can then be used to construct AMOs onboard the BTFDD's deck. When construction is complete, the AMFDD can lower itself into the water, and/or the BTFDD can raise its keel, thereby allowing the BTFDD to float, propel, be towed, and/or otherwise move away from the AMFDD.

The BTFDDs now containing AMOs can move to a port or other location for offloading or to a location at which it may deploy AMOs into the water. The BTFDD can deploy AMOs it contains by lowering itself into the water far enough to permit the AMOs to float. Once they are floating, the AMOs may be moved away from the BTFDD. The BTFDD can then raise its deck above the water's surface and move back to the AMFDD to participate in the disclosed process again.

It should be noted that BTFDDs are not required for AMFDDs to function. One embodiment disclosed shows an AMFDD constructing AMOs on its own deck, then deploying them in water by lowering its deck below the water surface enough to move the AMOs away.

The disclosed dockside additive manufacturing embodiment is similar to an AMD utilized on board an AMFDD, but this embodiment is instead located over a channel located at a dock or similar location. The AMD has wheels, treads, a rack-and-pinion mechanism, or some other means that allows it to move, and/or translate, along the dock channel. FDDs or other vessels may be positioned beneath the AMD. The AMD can additively manufacture one or more AMOs on the deck of the vessel beneath it. Once construction of at least one AMO is complete, the vessel can leave the dock and move the at least one AMO to a new location for storage or deployment.

The technologies disclosed herein facilitate the systematic and/or automated printing of AMOs, layer-by-layer, as with and/or by a “3D printer.” This mode of fabrication has the advantage that arbitrarily complex and/or significant changes can be made to the design of the structure of the flotation module, buoyant structure, and/or buoy, and the modified design can be immediately fabricated. That is, there is no need to rebuild molds, update schematics to guide a manual fabrication process, etc.

Automated printing of modules, structures, and/or components, as disclosed herein, is highly conducive to and/or facilitates the ability to “scale” (i.e., repeat many times) the fabrication and/or production of such objects, and has the potential to significantly reduce the cost of their production, both in terms of minimizing the amount of fabrication material required, and reducing the amount of manual labor and/or supervision required during their production.

The technologies disclosed herein may be supplemented by the use of one or more molds, potentially including inserts made of foam, and/or some other low-density material, into which and/or around which the fabrication material is extruded and/or deposited. And, the technologies disclosed herein may be used with structural “skeletons” made of metal or another rigid material into which and/or around which the fabrication material is extruded and/or deposited.

The technologies disclosed herein can be used to extrude and/or deposit any material, and no limitation as to the material(s) of fabrication is expressed or implied. One embodiment involves and facilitates the extrusion and/or deposition of concrete. Another embodiment involves and facilitates the extrusion and/or deposition of one or more cementitious materials. Another embodiment involves and facilitates the extrusion and/or deposition of plastic. Another embodiment involves and facilitates the extrusion and/or deposition of ceramic materials. Another embodiment involves and facilitates the extrusion and/or deposition of composite materials. Another embodiment involves and facilitates the extrusion and/or deposition of polymers. Another embodiment involves and facilitates the extrusion and/or deposition of metallic materials. Another embodiment involves and facilitates the extrusion and/or deposition of glass. Another embodiment involves and facilitates the extrusion and/or deposition of crystalline materials. Another embodiment involves and facilitates the extrusion and/or deposition of meta-materials.

The technologies disclosed herein include embodiments wherein structural reinforcements and/or components are inserted into the extruded material as the structure is being fabricated. For example, one embodiment involves and facilitates the extrusion and/or deposition of cement through a “nozzle,” wherein during the extrusion and/or deposition process, steel pins, wires, meshes, and/or other metallic inserts are automatically inserted into the material, e.g. by a separate robotic arm.

The modules, structures, and/or components that can be created by the disclosed technologies include embodiments that are pre-stressed, such as by the use, and/or imposition, of post-tensioning tendons.

The modules, structures, and/or components that can be created by the disclosed technologies include embodiments that incorporate structural features, especially those fabricated through the use of 3D printing of successive layers of material, that provide and/or support “open voids,” and/or recessed spaces, within the created structure, into which other structural and/or operational components can be placed, fitted, affixed, and/or secured, and/or into which lightweight void-filling material can be deposited. One embodiment floods and/or fills at least one of these open voids with material such as closed-cell polymer or plastic foam.

The embodiments discussed herein utilize 3D printers that are permanently and/or temporarily mounted on, and/or affixed to, floating-dry-dock vessels. In some embodiments, these 3D printers position and/or control their nozzle(s) via actuation in at least three linear degrees of freedom. However, the scope of this disclosure also includes embodiments that utilize 3D printers which include, but are not limited to, any and/or all of the following varieties as well:

Any 3D printer variety that replaces one or more of the material nozzle(s)'s 3 linear degrees or freedom with a rotative degree of freedom can be used with the present invention, as well as any 3D printer variety whose nozzle(s) utilizes more or less than 3 degrees of freedom.

The embodiments discussed herein also include those that fabricate AMOs entirely through 3D printing. However, the scope of this disclosure includes embodiments that fabricate portions of, and/or entire, AMOs by means of pouring cementitious materials, resins, and/or other extrudable and/or pourable materials, into molds in which they are hardened. The material deposition nozzle of an additive manufacturing device can be used to deposit some or all of the material into a cast or mold.

3D printing as discussed herein includes, but is not limited to, any and/or all of the following:
Depositing material in a freeform fashion, where no supports, and/or external structures, are utilized.
Depositing material on and/or around one or more support structures, skeletons, lattices, etc. (e.g. those made of metal) which can be left in place and/or removed after fabrication is complete. Said structures, skeletons, and/or lattices can be “exoskeletons” that form the outer boundary of an AMO, and/or they can be “endoskeletons” that form an interior structure of an AMO.
Depositing material into a mold, form, cast, etc.

While much of this disclosure is discussed in terms of wave energy converters, both buoyant and submerged components and/or modules, it will be obvious to those skilled in the art that most, if not all, of the disclosure is applicable to, and of benefit with regard to, other types of buoyant devices and/or submerged devices, and/or components of devices (such as wind turbine towers) whose typical mode of deployment involves direct attachment to the seafloor, and all such applications, uses, and embodiments, are included within the scope of the present disclosure.

This disclosure, as well as the discussion regarding same, applies with equal force and equal benefit to the manufacture of: boats, buoys, barges, buoyant habitable structures (e.g., seasteading), bridges, artificial reefs, breakwaters, pipes and/or portions thereof (e.g., pipes utilized for the submerged transmission of fluids like sewage, oil, desalinated water, etc.), and other structures, objects, vessels, chambers, etc., that float at the surface of a body of water, rest on the ground beneath a body of water, and/or rest on ground above the surface of a body of water wherein at least a portion of that ground is proximate to a body of water.

### BRIEF DESCRIPTION OF THE DRAWINGS

For a fuller understanding of the nature and objects of the present invention, reference is made to the following detailed description, taken in connection with the accompanying drawings, in which:

FIG. 1 is a perspective view of a first embodiment of the present invention;

FIG. 2 is a perspective view of the embodiment of FIG. 1 in a subsequent stage;

FIG. 3 is a perspective view of the embodiment of FIG. 1 in another subsequent stage;

FIG. 4 is a perspective view of the embodiment of FIG. 1 in yet another subsequent stage;

FIG. 5 is a perspective view of the embodiment of FIG. 1 in still another subsequent stage;

FIG. 6 is a perspective view of the embodiment of FIG. 1 in another subsequent stage;

FIG. 7 is a perspective view of the embodiment of FIG. 1 in yet another subsequent stage;

FIG. 8 is a perspective view of the embodiment of FIG. 1 in still another subsequent stage;

FIG. 9 is a perspective view of the embodiment of FIG. 1 in another subsequent stage;

FIG. 10 is a perspective view of the embodiment of FIG. 1 in yet another subsequent stage;

FIG. 11 is a perspective view of an alternate embodiment of the present invention;

FIG. 12 is a perspective view of the embodiment of FIG. 11 in a subsequent stage;

FIG. 13 is a perspective view of the embodiment of FIG. 11 in another subsequent stage;

FIG. 14 is a perspective view of the embodiment of FIG. 11 in a yet another subsequent stage; and

FIG. 15 is a perspective view of another alternate embodiment of the present invention.

### DETAILED DESCRIPTION OF THE PREFERRED EMBODIMENTS

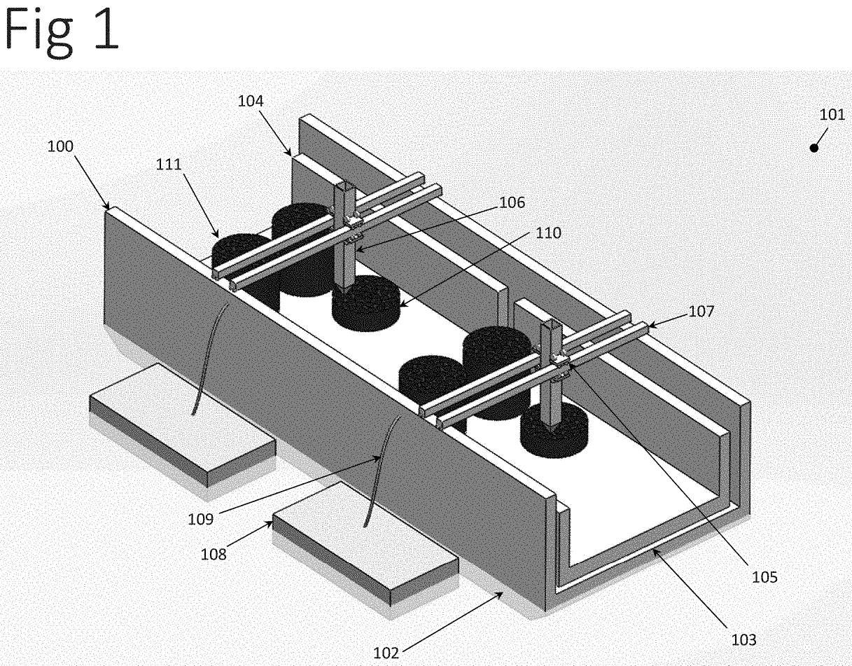

FIG. 1 shows a perspective view of an embodiment of the current disclosure. A large floating dry dock 100 is floating in a body of water 101 with waterline 102. The waterline 102 is the position of the dock 100 relative to the surface of body of water 101, and corresponds with a depth sufficient to keep the dock afloat, but not high enough to submerge its deck 103.

Upon the deck 103 of the larger floating dry dock 100 rests two smaller floating dry docks 104. The large dock 100 has mounted upon it two additive manufacturing devices 105, which include a material deposition strut 106, a trolley 105, and a gantry 107. Material deposition struts 106 extend along one axis relative to their respective trolleys 105, i.e., up and down relative to the horizontal deck 103 of the large floating dry dock 100. The trolleys 105 are constrained to and are able to move along one axis relative to their respective gantries 107, i.e., port to starboard relative to the large floating dry dock 100. The gantries 107 move along axes normal to their respective trolleys 105, i.e., fore and aft relative to the large floating dry dock 100.

With respect to this embodiment, material for the additive material devices is supplied via barges 108 through pipes or hoses 109 into the large floating dry dock 100. Deposition struts 106 construct and/or fabricate additively manufactured objects upon small floating dry docks 104. Additively manufactured objects 110 are under construction while additively manufactured objects 111 are complete.

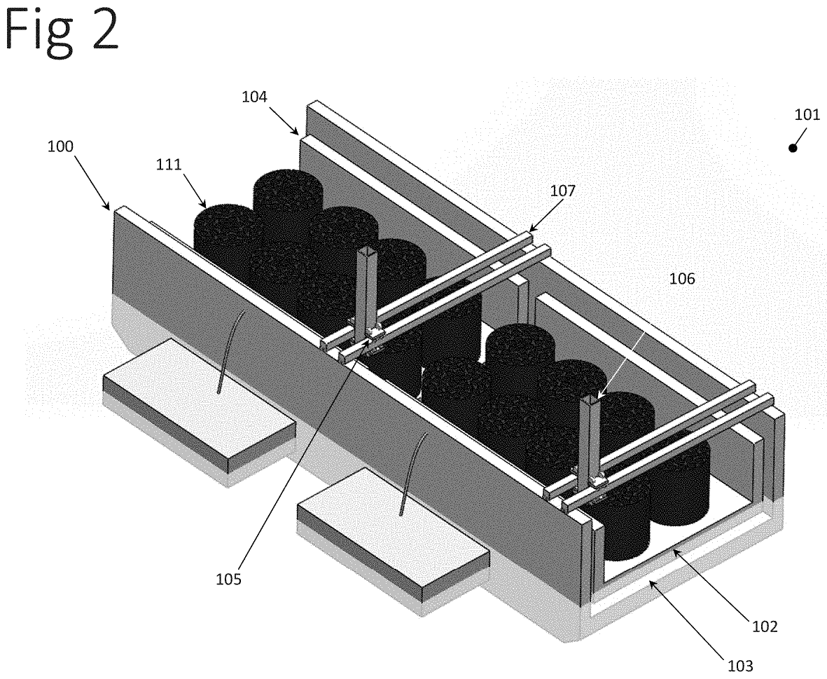

FIG. 2 depicts the embodiment of FIG. 1 configured in a manner representative of a subsequent step of the AMO fabrication process. Large floating dry dock 100 has increased its net weight (and/or decreased its buoyancy) such that it is the floating deeper in the body of water 101, i.e., waterline 102 has moved higher on large floating dry dock 100. In the illustrated configuration, waterline 102 has risen to the point that the deck 103 of large floating dry dock 100 is now submerged. Waterline 102 is also high enough that the smaller floating dry docks 104 are now floating in the body of water 101 and are no longer in contact with the deck 103 of large floating dry dock 100. The material deposition struts 106, trolleys 105, and gantries 107 have all moved along their respective axes, and/or degrees of freedom, to positions where they are farthest away from the additively manufactured objects 111.

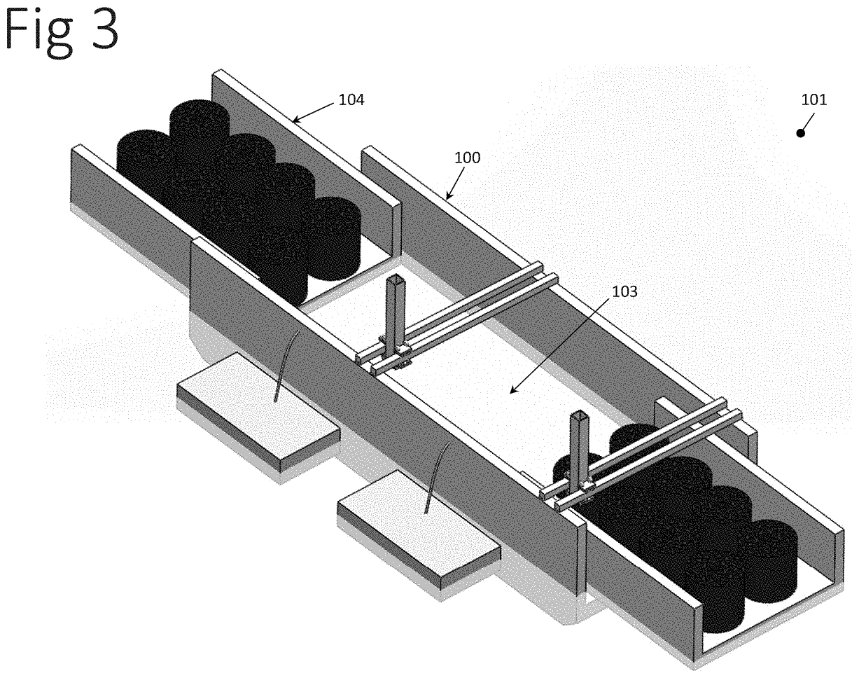

FIG. 3 shows the small floating dry docks 104 (i.e., the transport docks) floating and not in contact with the deck 103 (i.e., the manufacturing deck) of the large floating dry dock 100, and are able to move (or to be moved) away from large floating dry dock 100. In other embodiments (not shown), as aforementioned, a vertical separation between the keels of the small floating dry docks and the deck of the large floating dry dock is achieved not by the lowering of the large floating dry dock, but by the raising of the small floating dry docks.

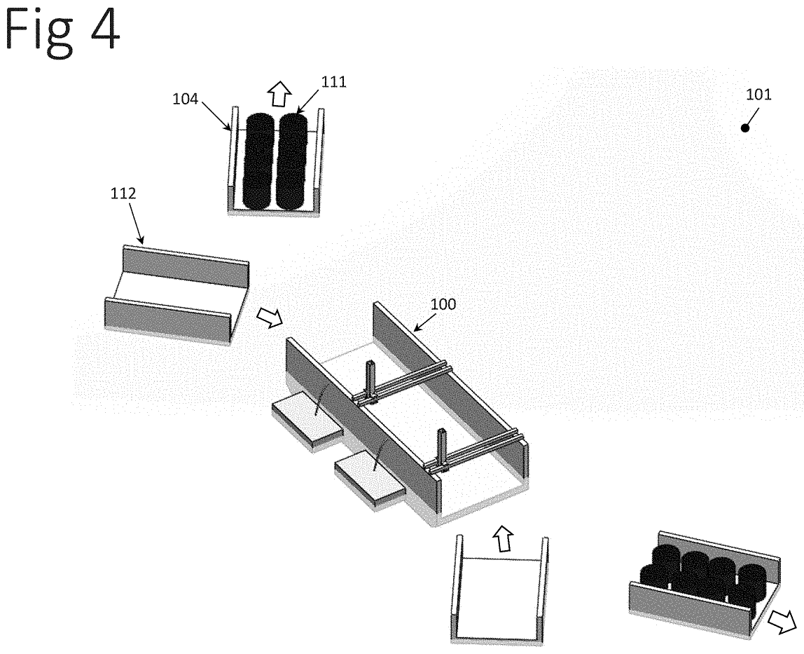

FIG. 4 shows the small floating dry docks 104 containing the constructed additively manufactured objects 111 continue to move away from large floating dry dock 100. Two “empty” small floating dry docks 112 move toward large floating dry dock 100 to replace the launched floating dry docks 104.

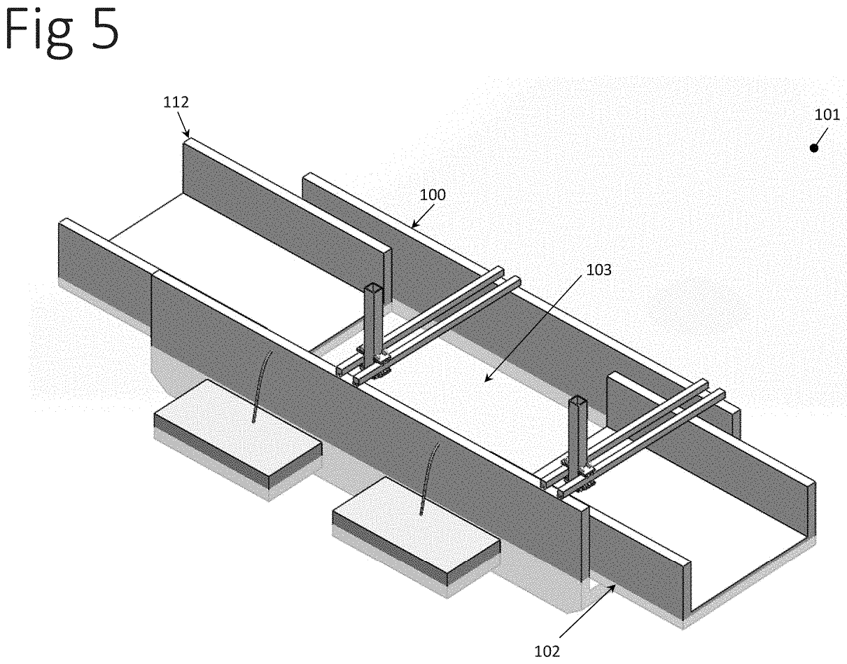

FIG. 5 shows the smaller “empty” floating dry docks 112 floating at a depth in body of water 101 with a shallow enough waterline 102 such that they are able to move into position on and/or above the deck 103 of the large floating dry dock 100 without making contact therewith.

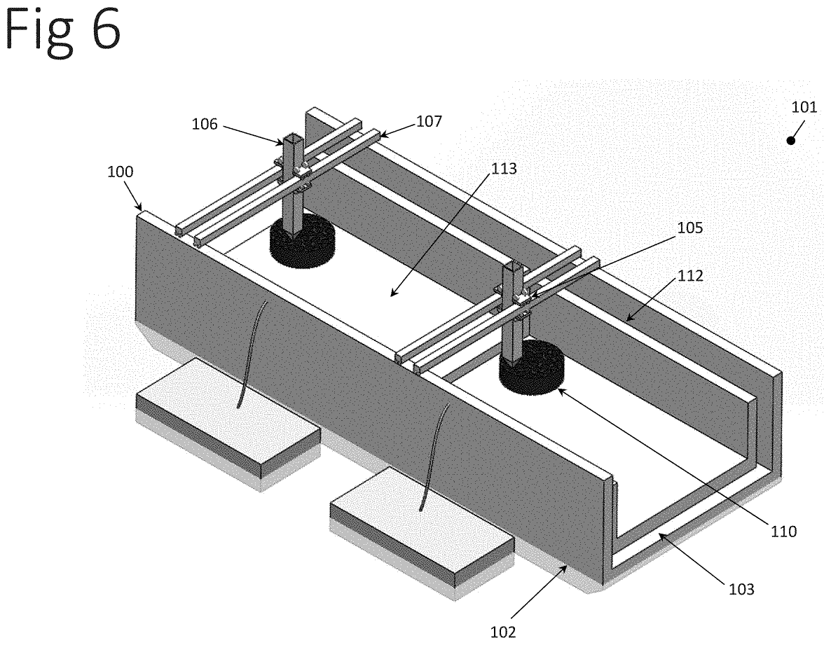

In FIG. 6, the smaller floating dry docks 112 have positioned their hulls over the deck 103 of the large floating dry dock 100. The large floating dry dock 100 has decreased its net weight (and/or increased its buoyancy) sufficiently so as to cause the waterline 102 to be positioned below the deck 103 of the large floating dry dock 100 on which the smaller floating dry docks 112 rest. Because the deck 103 of the large floating dry dock 100 has risen beneath them, the bottom surfaces of the small floating dry docks (i.e. their keels) have come to rest on the deck of large floating dry dock 100. Material deposition struts 106 on additively manufacturing devices 105, located on large floating dry dock 100, have begun to fabricate additively manufactured objects 110 on the decks 113 of the small floating dry docks 112. In this manner, the additively manufactured objects are being “3-D printed” on the decks of the small floating dry docks. In one manner of 3-D printing, a material such as cement is deposited by a “nozzle” in a linear and layered fashion, i.e. the movement of the nozzle defines contours, and the extrusion of material from the nozzle as it moves allows a structure to be built up. In some embodiments, said formed structure contains interior hollow voids so that the structure is buoyant.

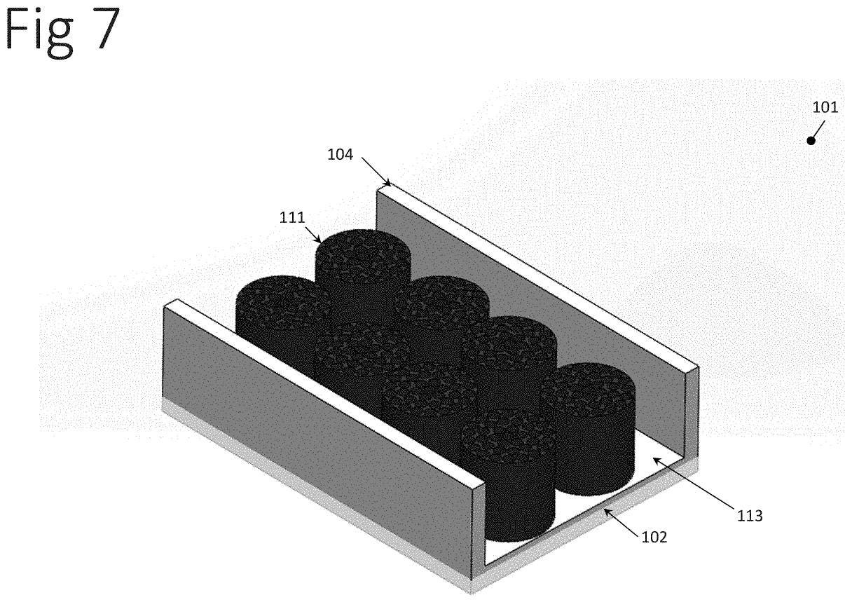

FIG. 7 shows the small floating dry dock 104 with eight additively manufactured objects 111 that have been fabricated on its deck 113. The small floating dry dock 104 is floating at a depth relative to the surface of body of water 101 such that the waterline 102 is below the deck 113 upon which the additively manufactured objects 111 have been fabricated.

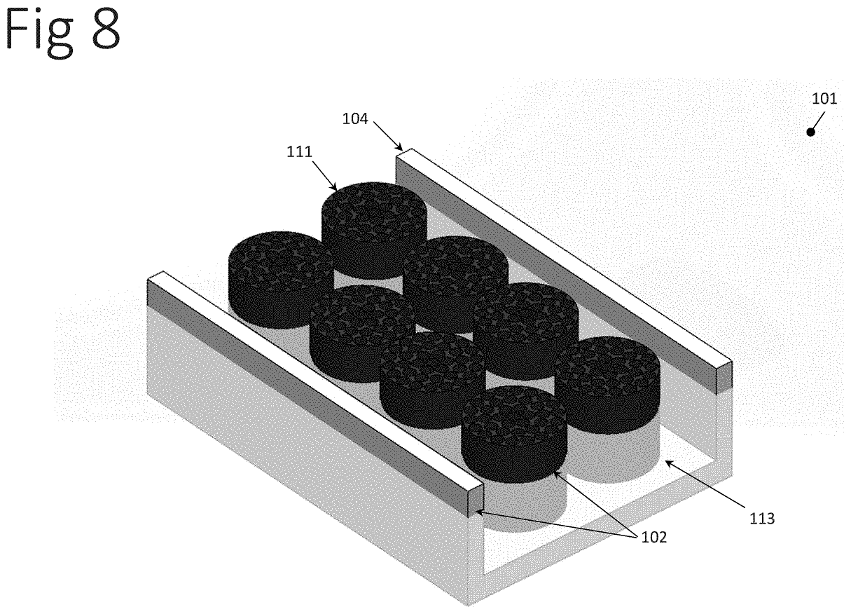

FIG. 8 shows the small floating dry dock 104 with eight additively manufactured objects 111 that have been fabricated on its deck 113. The eight additively manufactured objects 111 are now partially submerged adjacent to the surface of the water 101. The small floating dry dock 104 has increased its net weight (and/or decreased its buoyancy) so as to cause the surface of the body of water 101 to now be located above the upper surface of the deck 113 of the small floating dry dock 104. The deck 113 of the small floating dry dock 104 has lowered sufficiently into the water, and/or waterline 102 is sufficiently high, with respect to the additively manufactured objects 111 so that they are now floating in the water and no longer in contact with the deck 113 of the small floating dry dock 104.

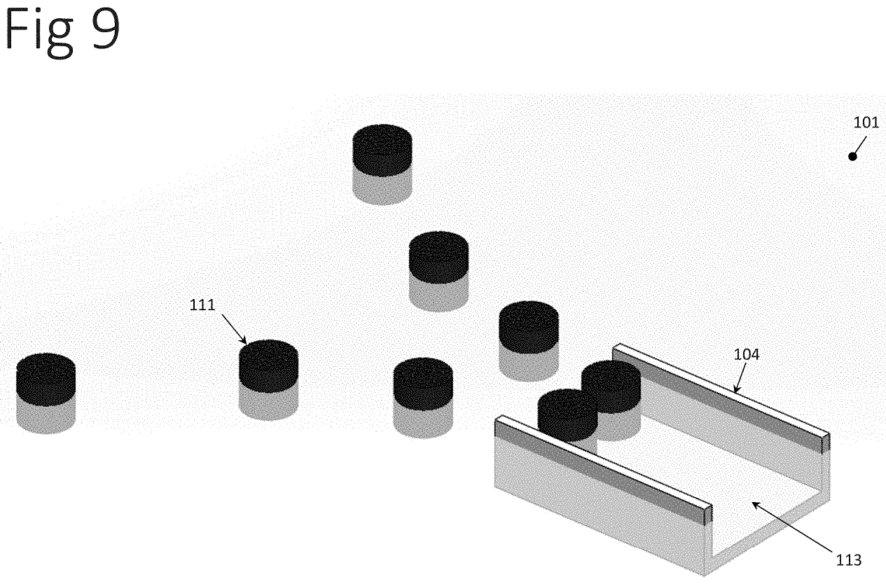

FIG. 9 shows the additively manufactured objects 111 that had been fabricated on to the upper deck 113 of the small floating dry dock 104 have moved themselves or been moved by external force(s) away from small floating dry dock 104. Structures aboard the small floating dry dock can facilitate this motion, e.g. mechanical arms, tracks, winches, rails, conveyors, cranes, etc.

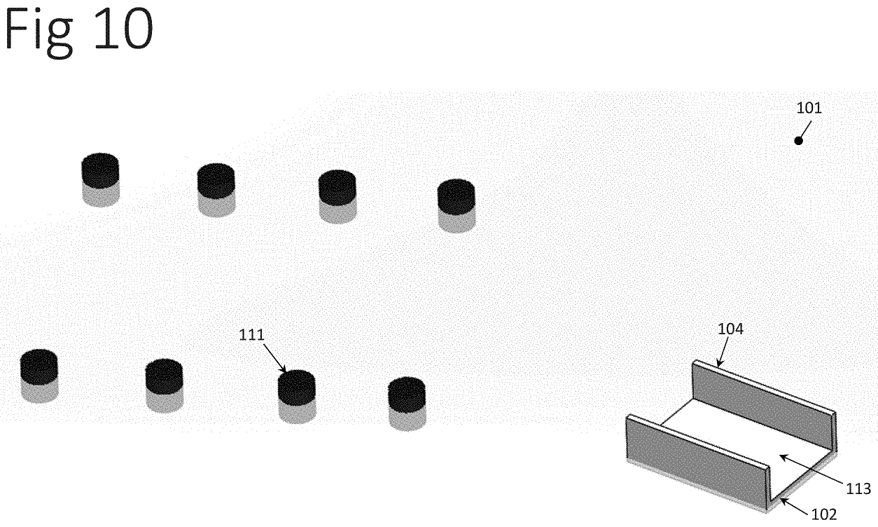

In FIG. 10, the additively manufactured objects 111 have all been offloaded from the small floating dry dock 104. Following the discharge of the additively manufactured objects, the small floating dry dock 104 has decreased its net weight (and/or increased its buoyancy) so as to move the waterline and thereby cause its deck 113 to rise from, and/or out of, the water. Small floating dry dock 104 is now ready to behave like the small floating dry docks 112 in FIG. 4, and move back to large floating dry dock 100 to begin a repetition of the disclosed process again.

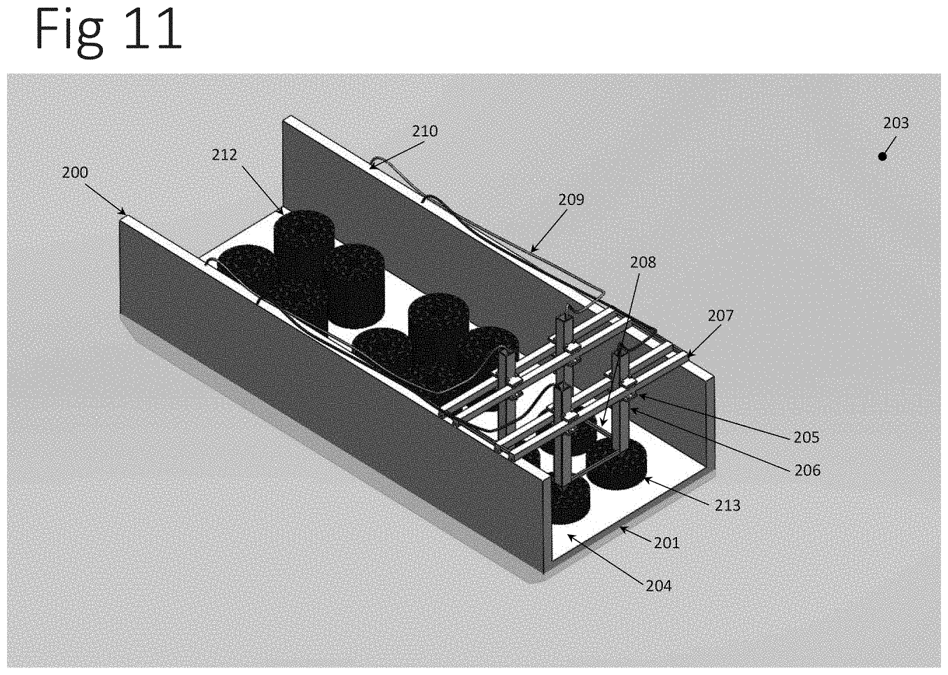

In FIG. 11, floating dry dock 200 is floating with a waterline 201. Waterline 201 demarks the depth, and/or vertical position, of the floating dry dock 200 relative to the surface of body of water 203 at which it is neutrally buoyant. Waterline 201 is sufficient to keep floating dry dock 200 afloat, but not high enough to submerge its deck 204. Floating dry dock 200 has installed/mounted upon it four additively manufacturing devices 205 that are comprised of material deposition struts 206, trolleys 205, gantries 207, and beams 208. The beams 208 force the deposition struts 206 to move in unison.

The deposition struts 206 can move along one axis relative to their respective trolleys 205 (i.e. up/down relative to floating dry dock 200). The trolleys 205 are constrained to and able to move along one axis relative to their respective gantries 207 (i.e. port/starboard relative to floating dry dock 200). The gantries 207 can move along an axis normal to their respective trolleys 205 (i.e. fore/aft relative to floating dry dock 200).

The material consumed by the additively manufacturing devices 205 during the fabrication process, is supplied through pipes/hoses 209 from respective tanks 210 internal to floating dry dock 200 (e.g. inside the vertical walls such as 211).

The deposition struts 206 are constructing additively manufactured objects 212 on the deck 204 of floating dry dock 200. Some of the additively manufactured objects, e.g. 213, illustrated in FIG. 11 are under construction, while others, e.g. 212, are complete.

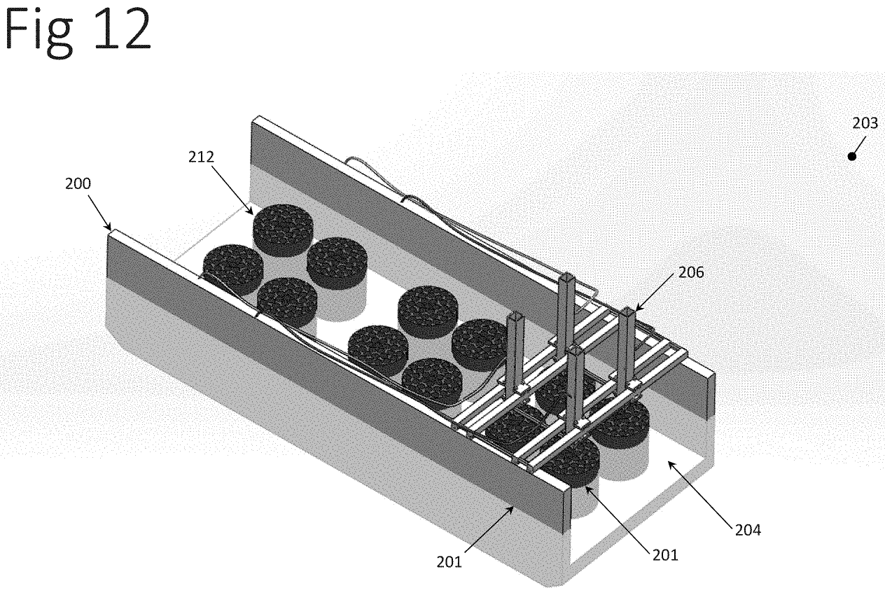

FIG. 12 shows floating dry dock 200 has increased its net weight (and/or decreased its buoyancy) so as to cause it to float deeper in the body of water 203.

In the illustrated configuration and/or fabrication step, waterline 201 is high enough so as to cause the deck 204 of floating dry dock 200 to be submerged. The waterline 201 is also high enough that the fabricated additively manufactured objects 212 are now floating in the body of water 203 and are no longer in contact with the upper surface of the deck 204. The material deposition struts 206 have moved upward and away from the deck of floating dry dock 200 to a position where they are above, and cannot contact, the additively manufactured objects 212.

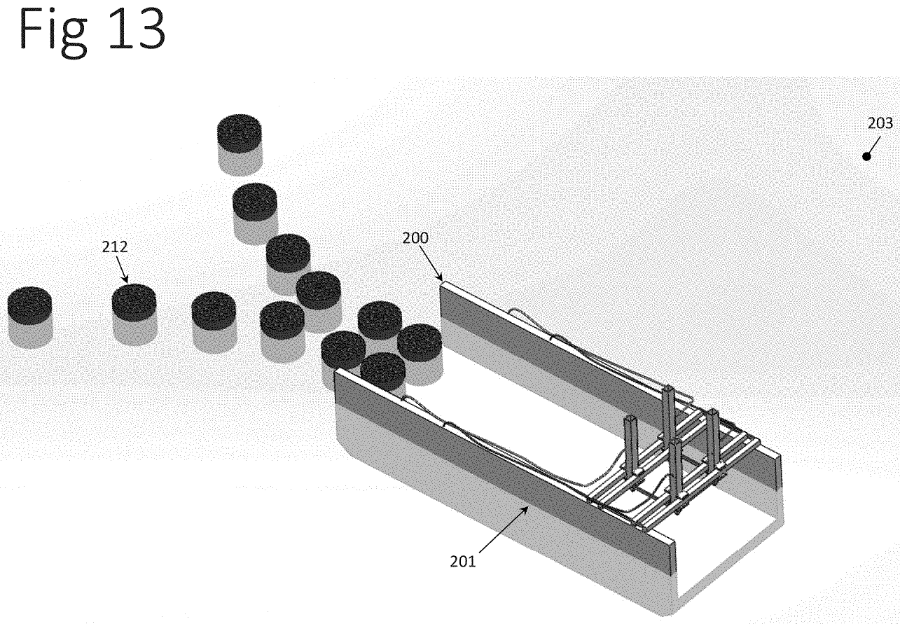

FIG. 13 depicts the floating and/or launched additively manufactured objects 212 have moved themselves or been moved by external force(s) away from floating dry dock 200.

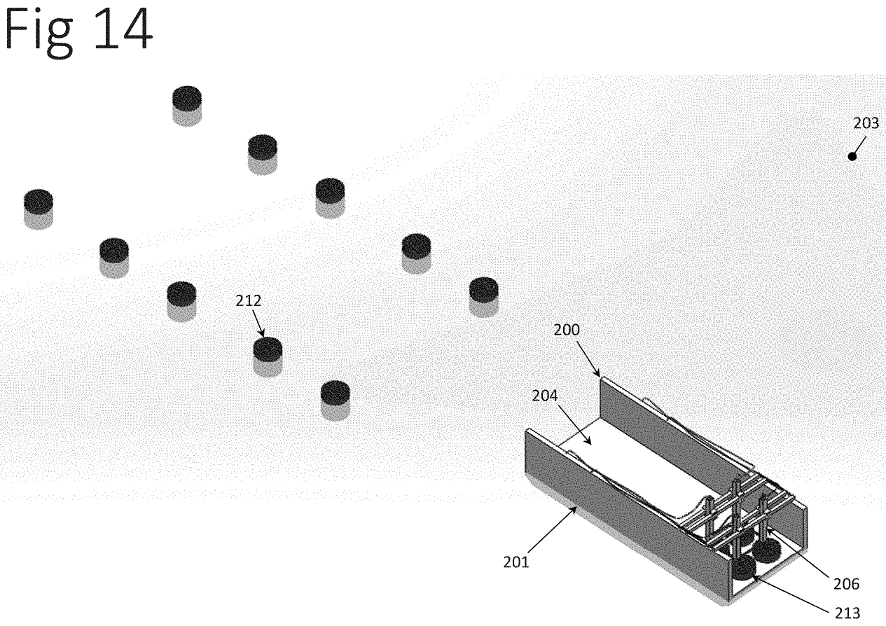

FIG. 14 shows the floating and/or launched additively manufactured objects 212 have been deployed into desired positions. Floating dry dock 200 has subsequently decreased its net weight (and/or increased its buoyancy) so as to cause its waterline 201 to be positioned below floating dry dock 200's deck 204, i.e., the deck 204 is now above the waterline and above the surface of the water. The material deposition struts 206 on floating dry dock 200 have begun to fabricate additional additively manufactured objects 213 on the deck of the floating dry dock 200.

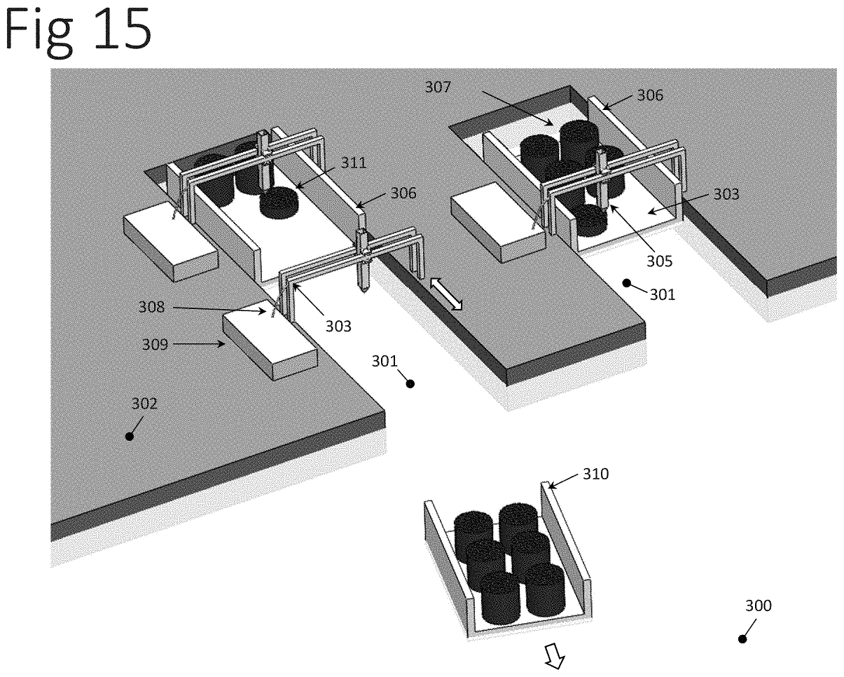

FIG. 15 shows a perspective view of another embodiment of the current disclosure. Body of water 300 is accessible within channels or apertures 301 within dock 302. The dock 302 may also be a wharf, pier, jetty, quay, land mass, etc. Three additively manufacturing devices 303 are shown on dock 302 and move along axes parallel to and/or over channels 301 in dock 302 via tracks/wheels/etc. The motions of the AMDs 303 and the respective material deposition struts 305 are similar to those described in connection with the embodiment of FIG. 1.

FIG. 15 shows three additively manufacturing devices 303, and respective channels 301, where it is understood that the number of AMDs and channels is arbitrary and not limited. Floating dry docks 306 can position themselves in channels 304 in such a way that the deposition struts 305 can construct additively manufactured objects 307 on the decks 303 of the floating dry docks 306. The material consumed during the fabrication process is supplied through pipes/hoses 308 from respective tanks 309. These tanks can be mounted aboard vehicles or vessels, e.g., trucks, rail cars, ships, or barges. Some of the illustrated additively manufactured objects, e.g. 311 are under construction, while others, e.g. 307, are complete. Floating dry docks 310 with completed additively manufactured objects may leave the dock 302 so as to transport the completed additively manufactured objects thereon to one or more new locations.

We claim:

1. A fabrication vessel for additively manufacturing and deploying objects while said fabrication vessel resides in a body of water, comprising:
a manufacturing dock disposed at a first vertical position with respect to a waterline of the body of water;
a transport dock receivable on the manufacturing dock for egress and ingress to the manufacturing dock;
an additive manufacturing device mounted on the vessel proximal to the transport dock for constructing an additively manufactured object on the transport dock;
wherein lowering the manufacturing dock to a second vertical position facilitates egress of the transportation dock resulting from at least a partial submergence of the transportation dock below the waterline.

2. The fabrication vessel of claim 1, wherein the second vertical position results in the transportation dock separating from the manufacturing dock due to the buoyancy of the transportation dock.

3. The fabrication vessel of claim 1, wherein the additively manufactured object is buoyant.

4. The fabrication vessel of claim 1, wherein the transport dock can propel to a remote location.

5. A fabrication vessel for additively manufacturing and deploying objects while said fabrication vessel resides in a body of water, comprising:
a manufacturing dock disposed at a first vertical position with respect to a waterline of the body of water; and
an additive manufacturing device mounted on the vessel proximal to the manufacturing dock for constructing an additively manufactured object on the manufacturing dock;
wherein lowering the manufacturing dock to a second vertical position facilitates removal of the additively manufactured object resulting from at least a partial submergence of the additively manufactured object below the waterline.

6. The fabrication vessel of claim 5, wherein the additive manufacturing device constructs multiple additively manufactured objects simultaneously.

7. The fabrication vessel of claim 5, wherein the additively manufactured objects are deployed directly into the body of water.

8. A method for deploying an additively manufactured object, comprising:
providing a vessel on a body of water having an additive manufacturing device located on the vessel;
positioning a first dock of the vessel at a first vertical position;
using the additive manufacturing device to generate an additively manufactured object on the first dock;
lowering the first dock until a force required to deploy the additively manufactured object is reduced; and
deploying the additively manufactured object into the body of water.

9. The method for deploying an additively manufactured object of claim 8, wherein the additively manufactured object is a component of a wave energy generator.

10. The method for deploying an additively manufactured object of claim 8, wherein the first dock is separable from the vessel, and wherein the first dock rests on a larger second dock during the generation of the additively manufactured object.

11. The method for deploying an additively manufactured object of claim 8, wherein a material used to generate the additively manufactured object is cement.

12. The method for deploying an additively manufactured object of claim 8, further comprising the step of supplying material to the additive manufacturing device with a second vessel adjacent the first vessel.

13. The method for deploying an additively manufactured object of claim 10, wherein the larger second dock accommodates a plurality of smaller docks.

14. The method for deploying an additively manufactured object of claim 8, wherein the additive manufacturing device generates multiple additively manufactured objects simultaneously and multiple additively manufactured objects can be deployed simultaneously.
